(19) United States
(12) Patent Application Publication
(10) Pub. No.: US 2016/0125166 A1
(43) Pub. Date: May 5, 2016

(54) INTEROPERABLE MEDICAL CODE

(71) Applicant: Arjuna Raja, Philadelphia, PA (US)

(72) Inventor: Arjuna Raja, Philadelphia, PA (US)

(21) Appl. No.: 14/530,795

(22) Filed: Nov. 2, 2014

(51) Int. Cl. G06F 19/00

(52) U.S. Cl. CPC G06F 19/3475

(57) ABSTRACT

A program product that includes an authentication system and a method for processing a medical order from a health practitioner is disclosed. The program product comprises an interoperable medical code containing a plurality of identifiers of information regarding the medical order. The identifiers are grouped into modules representing at least a practitioner identifier module, a patient identifier module, a medical requisition identifier module, a patient clinical information module and an order timestamp. The system further authenticates the interoperable medical code and generates the medical order from the interoperable medical code.

### RELATED APPLICATIONS

This application claims priority from provisional application number 61/901,076 filed on Nov. 7, 2013.

### FIELD OF THE INVENTION

The subject matter disclosed herein relates to medical codes and more particularly relates to an interoperable medical code.

### BACKGROUND OF THE INVENTION

Health care practitioners regularly generate medical orders such as pharmaceutical prescriptions, medical device prescriptions, test orders, procedure orders, and diagnostic orders that are fulfilled by other medical service providers.

### SUMMARY OF THE PRESENT INVENTION

In an embodiment of the present invention, a program product for processing a medical order from a health practitioner, said program product comprising an interoperable medical code, said interoperable medical code containing a plurality of identifiers of information regarding said medical order, said identifiers being grouped into modules representing at least a practitioner identifier module, a patient identifier module, a medical requisition identifier module, a patient clinical information module and an order timestamp.

These and other features, aspects and advantages of the present invention will become better understood with reference to the following drawings, description and claims.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an interoperable medical code system;

FIG. 2 is a schematic block diagram illustrating one embodiment of an interoperable medical code;

FIGS. 3-8 are illustrations of embodiments of medical orders;

FIG. 9 is a schematic flow chart diagram illustrating one embodiment of a medical order communication method;

FIG. 10 is a schematic flow chart diagram illustrating one embodiment of a patient information access method; and

FIGS. 11-14 represent samples of transmitted medical orders.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including program code, firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible, non-transitory computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The wireless connection may be a mobile telephone network. The wireless connection may also employ a WiFi network based on any one of the Institute of Electrical and Electronics Engineers (IEEE) 802.11 standards. Alternatively, the wireless connection may be a BLUETOOTH® connection. In addition the wireless connection may employ a Radio Frequency Identification (RFID) communication including RFID standards established by the International Organization for Standardization (ISO), the International Electrotechnical Commission (IEC), the American Society for Testing and Materials (ASTM), the DASH7 Alliance, and EPCGlobal.

Alternatively, the wireless connection may employ a ZigBee connection based on the IEEE 802 standard. In one embodiment, the wireless connection employs a Z-Wave connection as designed by Sigma Designs. Alternatively, the wireless connection may employ an ANT and/or ANT+ connection as defined by Dynastream Innovations Inc. of Cochrane, Canada.

The wireless connection may be an infrared connection including connections conforming at least to the Infrared Physical Layer Specification (IrPHY) as defined by the Infrared Data Association (IrDA). Alternatively, the wireless connection may be a cellular telephone network communication. All standards and/or connection types include the latest version and revision of the standard and/or connection type as of the filing date of this application.

The description of elements in each figure may refer to elements of proceeding figures. Like numbers refer to like elements in all figures, including alternate embodiments of like elements.

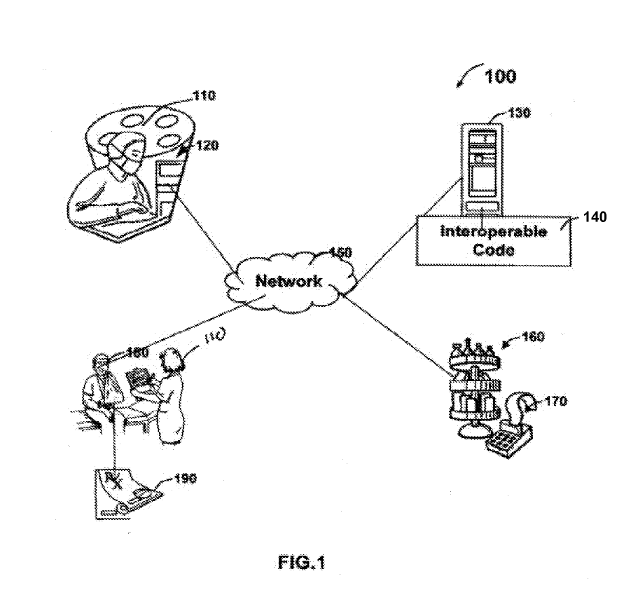

FIG. 1 illustrates a graphical representation of an interoperable medical code system 100 for securely managing medical orders and/or medical records with respect to a patient 180 within the medical environment. The system 100 includes a server 130 with a web interface for hosting a website and/or one or more database servers, wherein the server 130 is configured for managing information relating to medical personnel, electronic prescribing software, third party electronic prescription providers, pharmacies, and/or patients. The server 130 of the system 100 serves to create and allow access to created individual medical personnel files. The interoperable medical code system 100 described herein provides a secure 4-way communication between the server 130, a health care practitioner 110, a medical service provider 160, and a patient 180 respectively.

An electronic prescription generation application 120 at the health care practitioner 110 can be employed for generation of at least one e-prescription 190 with respect to the patient 180. The electronic prescription generation application 120 may communicate the e-prescription 190 to the server 130.

The server 130 includes a centralized database. The centralized database receives and stores the e-prescription 190 along with an interoperable medical code 140 with respect to the patient 180 for future retrieval. The centralized database may also store patient information for the patient 180. A medical order retrieval application 170 at a medical service provider 160 can be utilized to retrieve the electronic prescription 190 with respect to the patient 180 using the interoperable medical code 140 in order to view and deliver the prescribed services, tests, diagnostics, treatments, procedures, drugs and medical items, referred to hereafter as medical services, with respect to the patient 180.

The physical copy or e-mail of the e-prescription 190 with the interoperable medical code 140 can be provided to the patient 180 in order to permit him to obtain the medical services at any medical service provider 160.

The health care practitioner 110 at the electronic prescription generation application 120 can generate the e-prescription 190 and send the e-prescription 190 to any preferred medical service provider 160 requested by the patient 180. The users of the e-prescription system 100 such as health care practitioners 110, medical service providers 160, insurance providers, therapy providers, test order service labs, specialists, and Medicare units and government departments can obtain credentials from the system 100.

The patient 180 can collect the medical services at the medical service provider 160. The medical service provider 160 can authenticate the interoperable medical code 140 with respect to the patient 180 for accessing the e-prescription 190 at the system 100. Also, the medical service providers 160 and patients 180 can directly collect the medical services at a non-preferred medical service provider 160 by providing the physical copy of the prescription 190 with proper identification information. The non-preferred medical service provider 160 can verify the interoperable medical code 140 printed on the patient's prescription 190, and on comparing and matching the interoperable medical code 140 can issue the medical services to the patient 180. The system 100 therefore can allow the health care practitioners 110 to readily and securely exchange the medical order and patient information directly with other health care providers. The system 100 also permits the medical practitioners 110 to send prescription, refill orders, dose changes etc. to a medical service provider 160 such as a mail-order pharmacy on-line by avoiding direct or telephonic interactions between the users of the system 100.

The interoperable medical code system 100 permits the patient 180 to receive medical services such as collecting prescribed drugs at a pharmacy or any other medical service provider 160 at any location and time with proper authentication by the system 100. The medical service provider 160 may access the centralized database using a medical provider credential. Alternatively, the medical service provider 160 may log into the server 130 and access the patient information from the centralized database using a patient identifier and a medical provider credential. Credentials may include user accounts and/or passwords.

The patient 180 can retrieve specific reports for the patient 180 from the centralized database of the system 100. The patient 180 may access the centralized database using a patient credential. Alternatively, a patient biometric value such as the patient's thumb print can be used to access into the centralized database for accessing the medical records or authenticating records for medical service provider 160. By only allowing access to the system 100 with secure credentials, the system 100 ensures high level of data secured by protecting sensitive medical records such as, HIV or drug test positive reports with respect to the patient 180.

The interoperable medical code system 100 maintains the access details of access by the medical service provider 160 in an access log file to archive security details. The electronic prescription generation application 120 at the medical practitioners 110 permits changes to the medical order such as, dose, quantity and strength of medicine with respect to the patient 180 in the centralized database of the e-prescription 190 of the patient 180. The electronic prescription generation application 120 also permits the health care practitioner 110 to disable the interoperable medical code 140 and/or the e-prescription 190 in response to commands from the health care practitioner 110. The system 100 permits the patient 180 to view their prescription from centralized database by using the interoperable medical code 140 without editing or deleting the record. The electronic prescription 190 with respect to the patient 180 can be viewed through centralized database at different hierarchy levels depending upon privileges for medical practitioners 110, medical service provider 160 and the patient 180.

The system 100 may include additional communications links, which may be any communications links suitable for communicating data, e.g., between server and devices, such as network links, dial-up links, wireless links, hard-wired links, satellite links, any other suitable communications links, or a combination of such links. In one embodiment, the communications with the server 130 is secure and may include an encryption function and only individuals having an authorized code can access the system 100.

The centralized system 100 described herein provide effective 3-way means for communicating prescriptions 190, through a network 150 such as the internet or other suitable communication methods. The system 100 may allow access by medical service providers 160 having a credential. The system 100 is further configured for creating business accounts for medical service providers 160, healthcare practitioners 110, and/or third party electronic prescription providers or software, and configured for editing the accounts by authorized personnel.

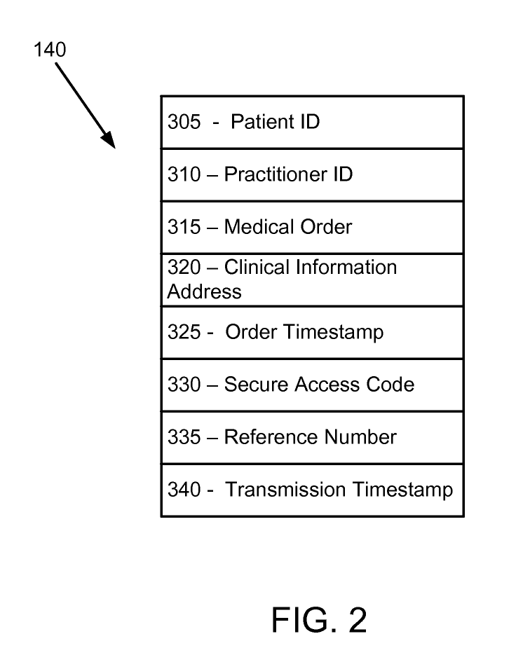

FIG. 2 is a schematic block diagram illustrating one embodiment of an interoperable medical code 140. The interoperable medical code 140 includes a patient identifier 305, a practitioner identifier 310, the medical order 315, a clinical information address 320, an order time stamp 325, a secure access code 330, a reference number 335, and a transmission time stamp 340. The patient identifier 305, practitioner identifier 310, medical order 315, clinical information address 320, order time stamp 325, secure access code 330, reference number 335, and transmission timestamp 340 may each comprise alphanumeric strings stored in a data field.

The patient identifier 305, practitioner identifier 310, medical order 315, clinical information address 320, order time stamp 325, secure access code 330, reference number 335, and transmission timestamp 340 may each be separately encrypted. In one embodiment, the interoperable medical code 140 is also encrypted.

The patient identifier 305 may uniquely identify the patient 180. The patient identifier 305 may include a patient code, a patient name, a patient address, patient contact information, patient insurance information, and the like.

The practitioner identifier 310 may uniquely identify the health care practitioner 110. The practitioner identifier 310 may include a practitioner code, a practitioner name, and/or practitioner contact information.

Medical order 315 is the medical order generated by the health care practitioner 110. The medical order 315 may include but is not limited to one or more of a pharmaceutical prescription, a medical device prescription, a service order, and a diagnostic order.

The clinical information address 320 may be a database index number, a Universal Resource Locator (URL), patient reference number, or combinations thereof that identify clinical information for the patient 180. The clinical information may comprise patient information including but not limited to health care practitioner reports, diagnostic test results, emergency medical reports, and the like.

The order timestamp 325 may indicate a time that the medical order 315 was generated by the health care practitioner 110. The transmission timestamp 340 may indicate a time that the interoperable medical code 140 and/or e-prescription 190 are transmitted to the medical service provider 160.

The secure access code 330 may be used to access the patient information on the centralized database. In one embodiment, the secure access code 330 is a secure key. The reference number 335 may be arbitrarily generated number identifying the interoperable medical code 140.

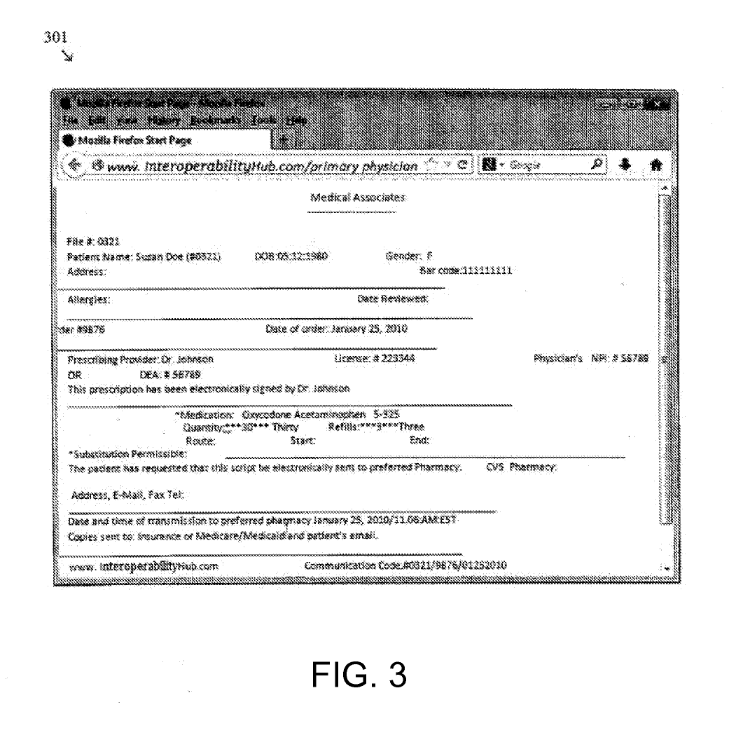

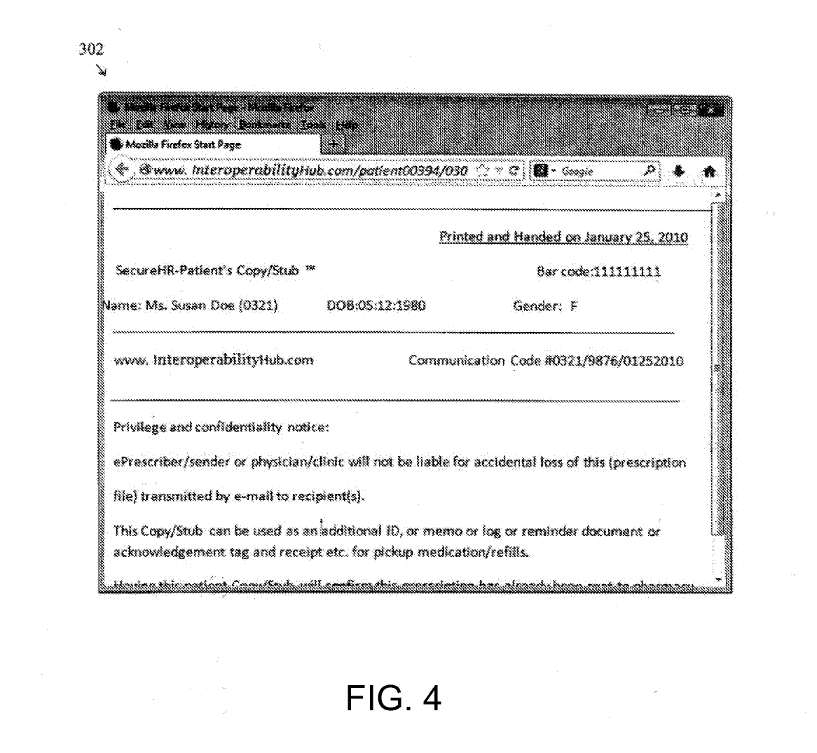

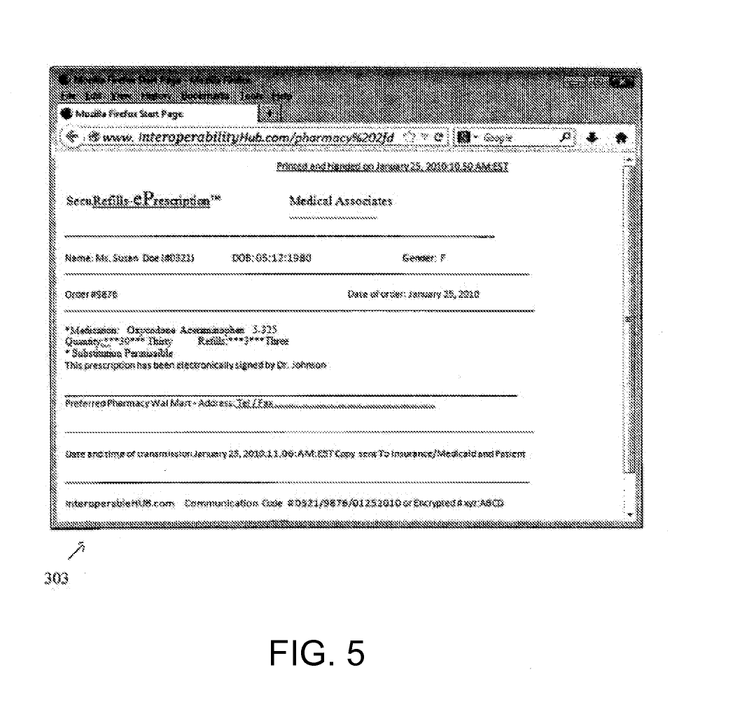

FIG. 3 illustrates the exemplary graphical user interface 301 of a primary physician screen where the health care practitioner 110 can provide and generate an e-prescription 190 with respect to the patient 180. FIG. 4 illustrates the exemplary graphical user interface 302 of an electronic prescription 190 viewed by the patient 180. The e-prescription 190 can be provided by adding privilege and confidentiality notice with respect the patient 180. FIG. 5 illustrates the exemplary graphical user interface 303 with respect to the preferred medical service provider 160. The graphical user interface at medical service provider 160 can also display the list of patients and drug dosage details.

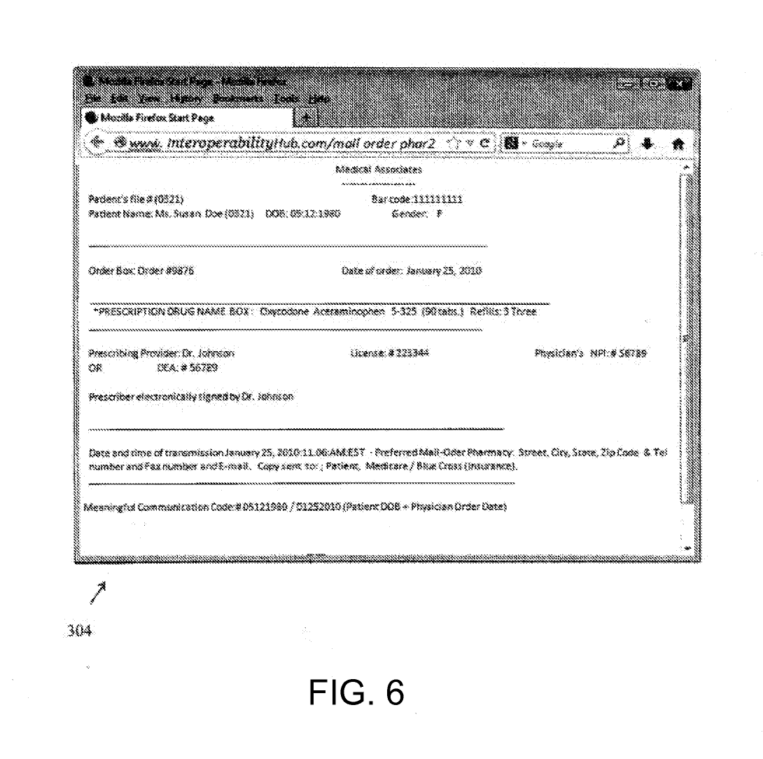

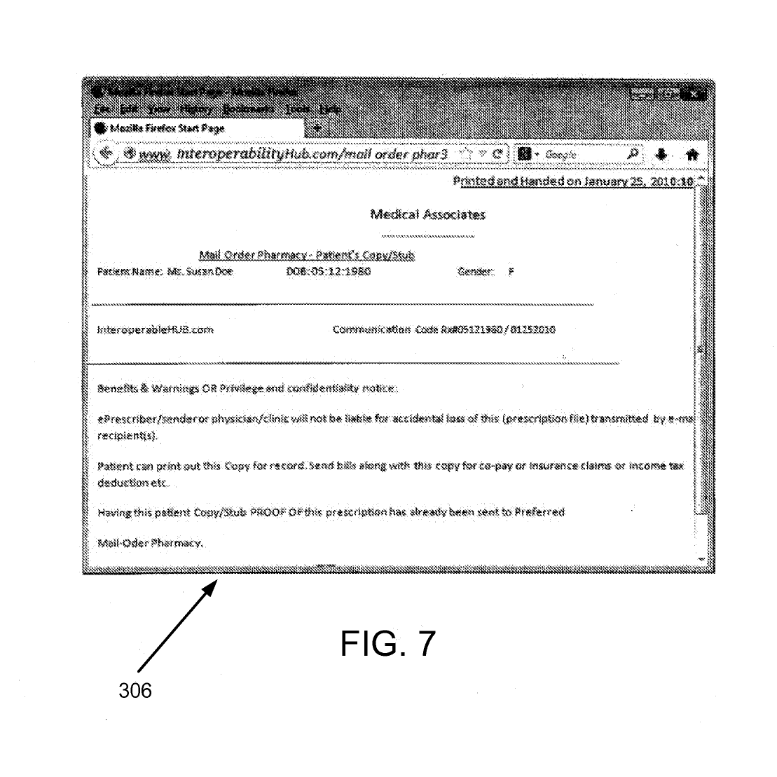

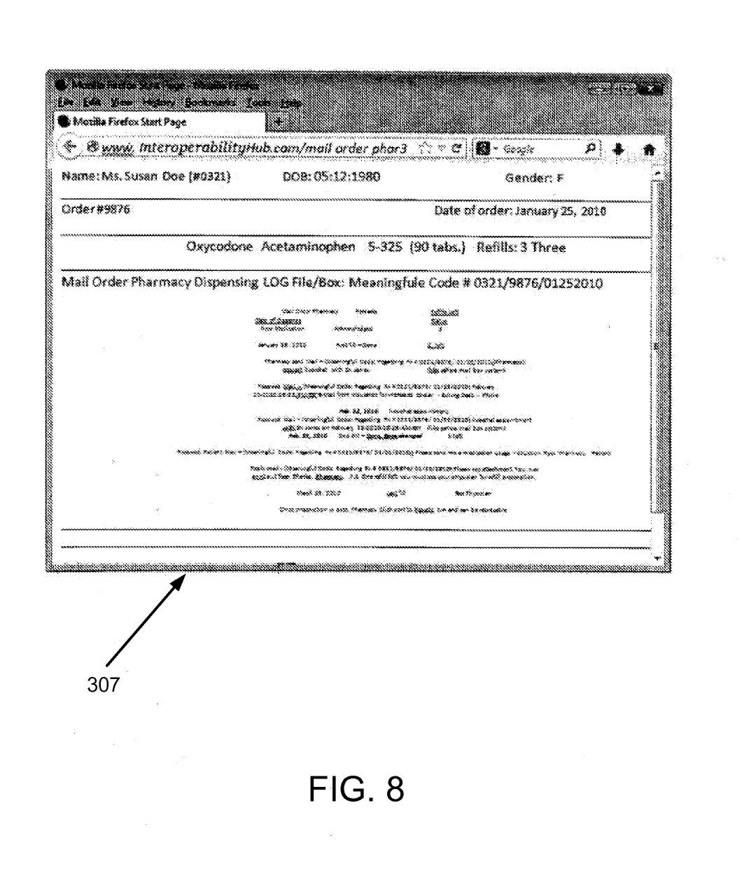

FIG. 6 illustrates the exemplary graphical user interface 304 of a mail order medical service provider 160. The meaningful communication code with respect to the patient 180 can be provided in order to view authentication verification and other details with respect to the patient 180. FIG. 7 illustrates the exemplary graphical user interface 306 of the e-prescription 190 which displays the case history and prescription with respect to the patient 180. FIG. 8 an exemplary graphical user interface 307 illustrating the e-prescription display at medical service provides 160 with respect to the patient 180.

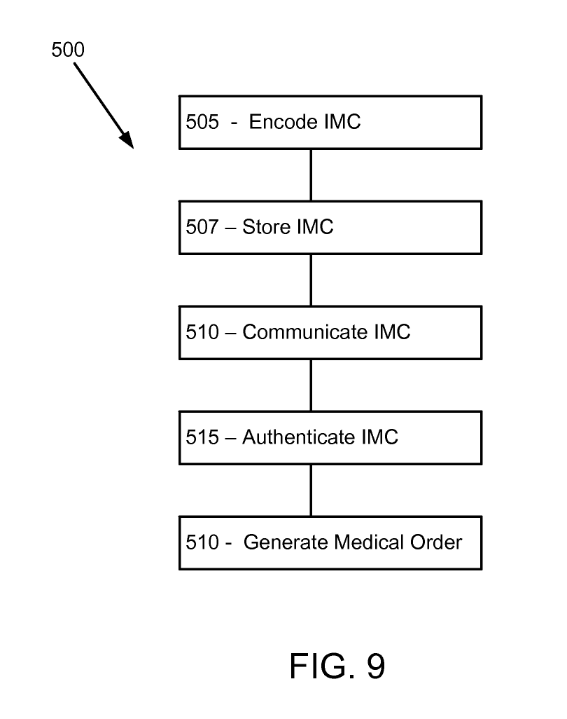

FIG. 9 is a schematic flow chart diagram illustrating one embodiment of a medical order communication method 500. The method 500 may encode the interoperable medical code 140 and generate the medical order 315 from the interoperable medical code 140. The method 500 may perform the functions of the system 100. The method 500 may be performed by use of a processor. Alternatively, the method 500 performed by a program product. The program product may include a computer readable storage medium storing program code. The processor may execute the program code to perform the functions of the method 500.

The method 500 starts, and in one embodiment the system 100 encodes 505 the interoperable medical code 140 in response to receiving a medical order 315 from the health care practitioner 110. In one embodiment, the system 100 validates the health care practitioner 110 using a biometric value such as a fingerprint scan. The system 100 may encrypt each of the patient identifier 305, practitioner identifier 310, medical order 315, clinical information address 320, order time stamp 325, secure access code 330, reference number 335, and transmission timestamp 340. In addition, the system 100 may encrypt the entire interoperable medical code 140.

In addition, the system 100 stores 507 the interoperable medical code 140 in the centralized database. The system 100 may also store 507 other patient information including clinical information in the centralized database.

For example, the health care practitioner 110 may consult with the patient 180 and generate an e-prescription 190 that includes the interoperable medical code 140 using the electronic prescription generation application 120. The electronic prescription generation application 120 may store the interoperable medical code 140 and/or e-prescription 190 in the centralized database. In one embodiment, the system 100 records the access to the centralized database by the health care practitioner 110.

The system 100 may further communicate 510 the interoperable medical code 140 and/or e-prescription 190 to the medical service provider 160. In one embodiment, the electronic prescription generation application 120 communicates 510 the interoperable medical code 140 and/or e-prescription 190 to the medical service provider 160. Alternatively, the interoperable medical code 140 and/or e-prescription 190 may be communicated 110 from the server 130. The interoperable medical code 140 and/or e-prescription 190 may be communicated 110 as one or more of an email, a text, and a chat. In one embodiment, the interoperable medical code 140 is communicated 110 to a preferred medical service provider 160.

In one embodiment, the electronic prescription generation application 120 also generates a physical copy of the interoperable medical code 140. The interoperable medical code 140 may be printed as one or more of an alphanumeric string, a barcode, and a Quick Response (QR) code. In a certain embodiment, the interoperable medical code 140 and/or e-prescription 190 is printed on an embossed substrate. The patient 180 may present the physical copy of the interoperable medical code 140 to medical service provider 160 including a non-preferred medical service provider 160 to receive the medical services specified by the medical order 315.

The system 100 may further authenticate 515 the interoperable medical code 140. In one embodiment, the medical service provider 160 communicates the interoperable medical code 140 to the centralized database and receives an authentication from the centralized database. Alternatively, the interoperable medical code 140 may be self-authenticating, allowing the medical service provider 160 to authenticate 515 the interoperable medical code 140 by decrypting one or more portions of the interoperable medical code 140.

The system 100 may further generate 520 the medical order 315 from the interoperable medical code 140. In one embodiment, the medical order is generated 520 in response to authenticating the interoperable medical code 140. The medical service provider 160 may then provide the medical service specified in the medical order 315 and the method 500 ends.

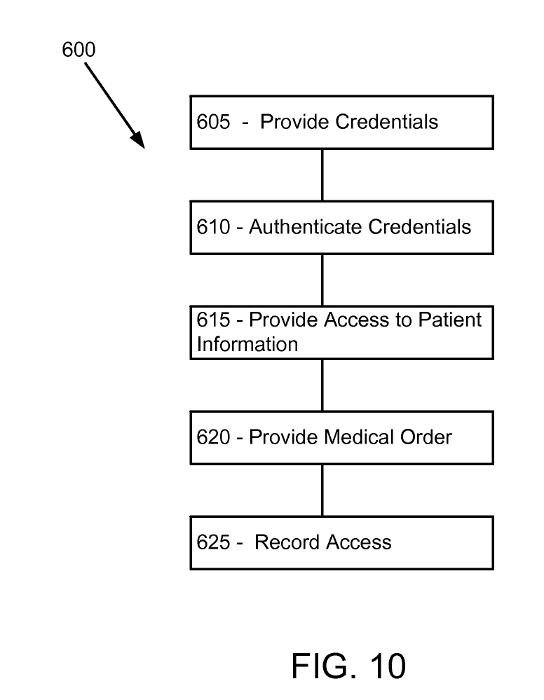

FIG. 10 is a schematic flow chart diagram illustrating one embodiment of a patient information access method 600. The method 600 may access the interoperable medical code 140, patient information, and/or the medical order 315. The method 600 may perform the functions of the system 100. The method 600 may be performed by use of a processor. Alternatively, the method 600 may be performed by a program product. The program product may include a computer readable storage medium storing program code. The processor may execute the program code to perform the functions of the method 600.

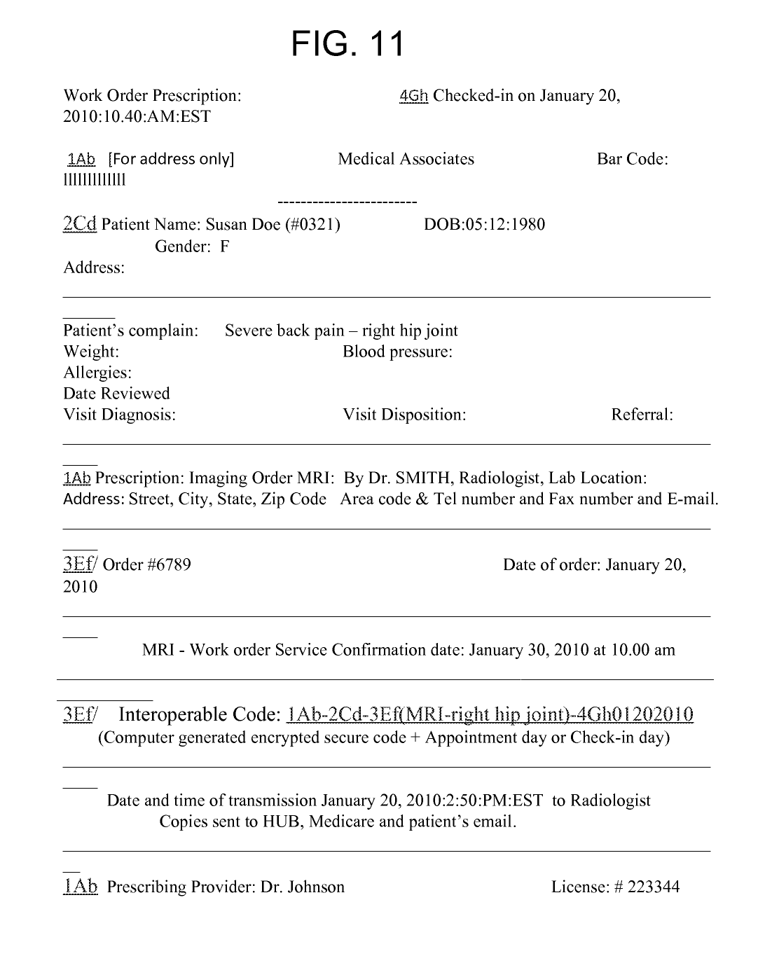

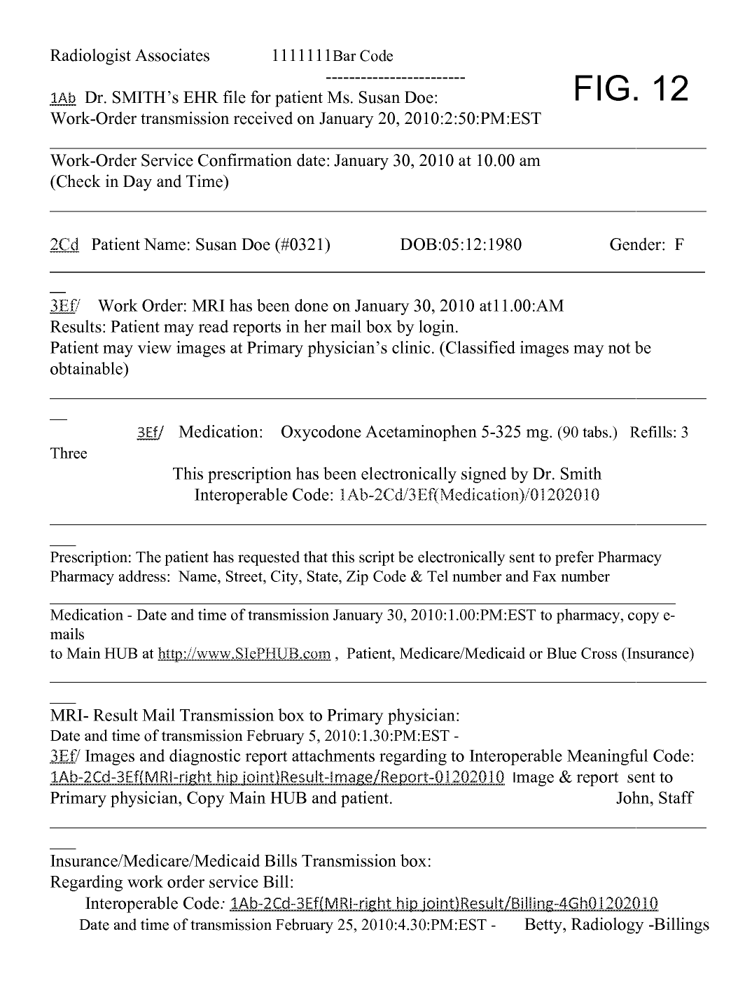

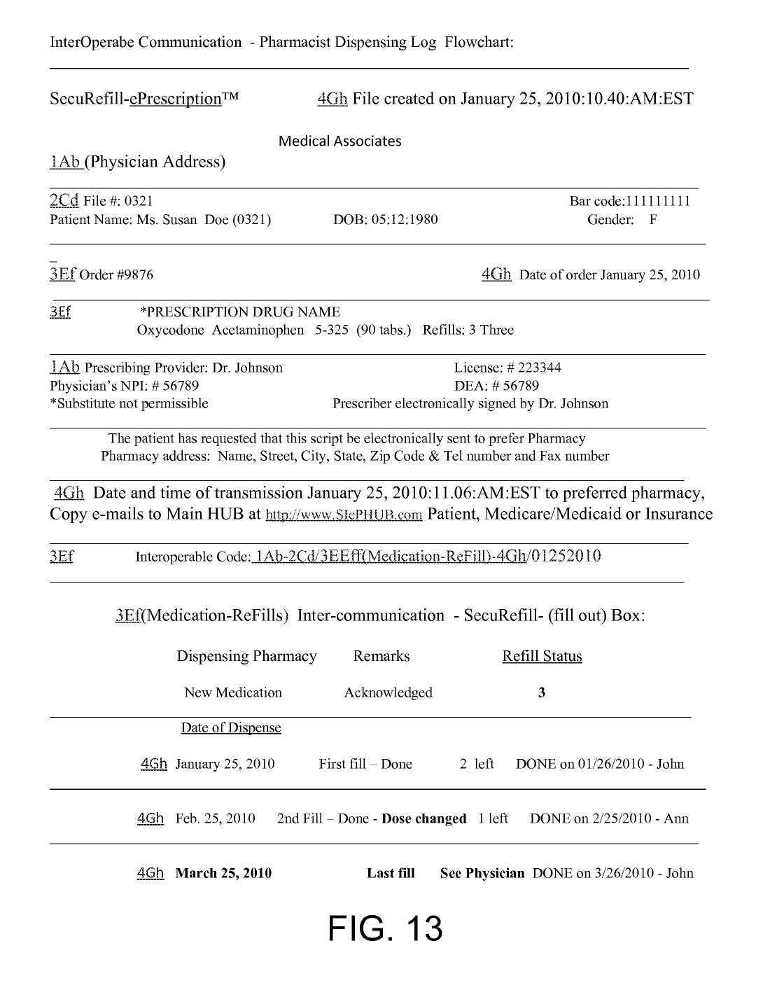

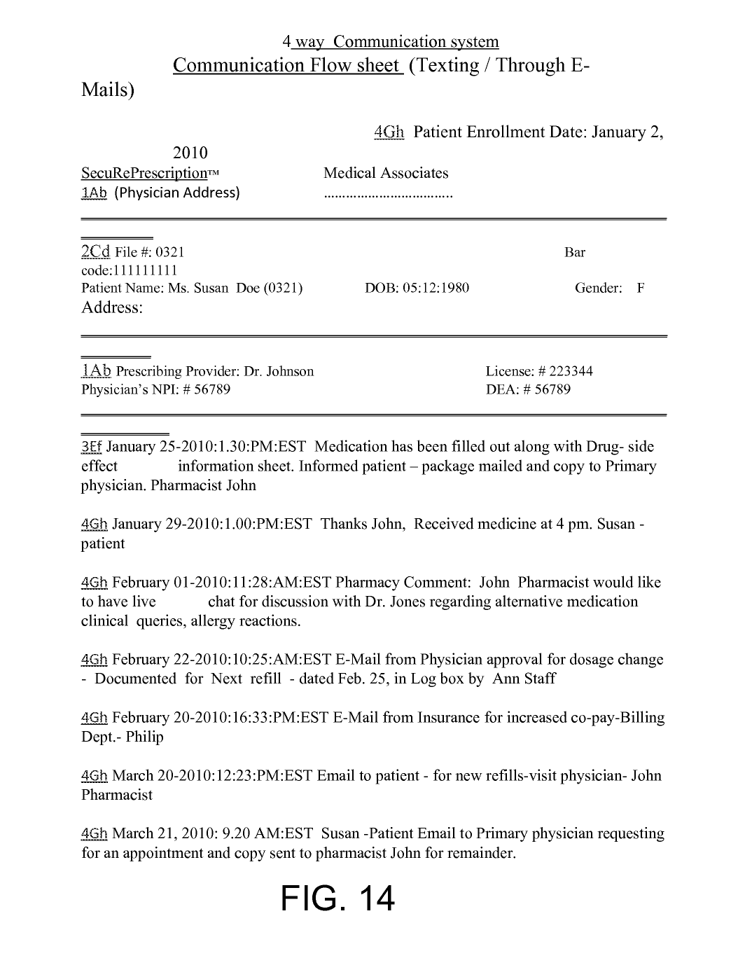

FIGS. 11 and 12 show transmission templates for two medical orders. The information in the code is organized in strings comprising of modules, with each module comprising identifiers relevant to the medical order. For example, in module 2Cd “2” represents the patient name (Susan Doe), “C” represents the patient's date of birth (May 12, 1980) and “d” represents the patient's gender. The string of all the modules constitutes the interoperable medical code. For the practitioner identifier module, 1AB, “1” may represent the name, “A” may represent the physician's license number while “b” may represent the physician's National Registration number. Additional information that may be added to the module the include patient's insurance policy, “g” in which case, the patient identifier module would be represented by “2Cdg”. Example of identifiers that would be added to the modules include but are not limited to: new patient, hierarchy of the patient's insurance policy (e.g. Humana being primary and Medicare being secondary), patient's health history, practitioner specialization field (e.g., cardiology), patient referral status (yes/no), pharmaceutical prescription, medical device prescription, a diagnostic order, a service order, refill eligibility, billing information, and pick up and shipping status. The modules in the strings are separated by a dash or a forward slash.

The interoperable code string may also comprise a text inserted between parentheses that spells out, for example, the type of order; e.g., medication or MRI. An example of such a string is shown in FIG. 12 as “1Ab-2Cd/3Ef(Medication)/01202010” where “Medication” is the order and 01202010 is the time stamp. Additional examples for strings are given below:
1Ab-2Cd-3Ef(MRI-right hip joint)-4Gh01202010
1AbcD-2EfgH-3IjkL-4MnoP-5QrsT-6UvwX
A12D/3Ef(Medication)01252010:10:30:AM

The identifier representation stays the same form one medical order to another while the information changes.

The method 600 starts, and in one embodiment, a credential 605 is provided to the centralized database. A patient 180, a healthcare provider 110, and/or a medical service provider 160 may provide 605 the credential. The credential may be the medical provider credential. Alternatively, the credential may be a patient credential. In one embodiment, the patient credential comprises the patient's full name concatenated with the date of birth for the patient and a healthcare practitioner identifier. The health care practitioner identifier may be the practitioner identifier 310. Alternatively, another identifier for the healthcare practitioner 110 may be used.

In one embodiment, if an emergency room possessed the full name and date of birth of the patient 180, and the healthcare practitioner identifier for the patient's physician, the emergency room could access the patient information from the centralized database. As result, critical patient information is accessible even without the interoperable medical code 140.

The system 100 may further authenticate 610 the credential. In response to authenticating the credential, the system 100 may provide access 615 to patient information including the interoperable medical code 140, the e-prescription 190, the medical order 315, and a patient report of one or more prescriptions in clinical information for the patient 180 from the centralized database. In one embodiment, the patient information comprises different hierarchy levels. Each hierarchy level may be accessible by specified access privilege associated with the credential. For example, a medical service provider 160 may be restricted from accessing one or more hierarchical levels of the patient information.

In one embodiment, the system 100 may also provide access 620 to the medical order 315. In one embodiment, the healthcare practitioner 110 may disable the interoperable medical code 140 and the medical order 315 using the command.

In one embodiment, the system 100 records 625 the access of the centralized database by the medical service provider 160, patient 180, and/or healthcare practitioner 110, in an access log file and the method 600 ends.

The interoperable medical code 140 allows healthcare practitioners 110 to securely and safely communicate medical orders to medical service providers 160. In addition, the interoperable medical code 140 may be used to securely access the patient information.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A program product for processing a medical order from a health practitioner, said program product comprising an interoperable medical code, said interoperable medical code containing a plurality of identifiers of information regarding said medical order, said identifiers being grouped into modules representing at least a practitioner identifier module, a patient identifier module, a medical requisition identifier module, a patient clinical information module and an order timestamp.

2. The program product of claim 1, wherein said modules are represented by strings separated by a dash, a set of parentheses or a forward slash.

3. The program product of claim 1 wherein said identifiers are selected from digits, lower case letters and upper case letters.

4. The program product of claim 3 wherein said modules further comprise at least one written text separated by a set of parentheses.

5. The program product of claim 1 wherein the patient identifier module comprises at least an identifier for a patient name, date of birth, and gender.

6. The program product of claim 5, said patient identifier module further comprises an identifier for a new patient, an identifier for a hierarchy of the patient's insurance policy and a code for a patient's health history.

7. The program product of claim 1 wherein the practitioner identifier module comprises an identifier for practitioner license number, an identifier for practitioner NP registration number, an identifier for practitioner specialty and an identifier for referral status.

8. The program product of claim 1 wherein the medical order identifier module comprises an identifier for each of a pharmaceutical prescription, a medical device prescription, a diagnostic order, a service order, and pick up and shipping status information.

9. The program product of claim 1, wherein the program product further comprises a secure access code, a reference number, and a transmission timestamp, and wherein each of the secure access code, the reference number and the transmission timestamp are separately encrypted.

10. The program product of claim 1, wherein a centralized database stores the interoperable medical code and patient information.

11. The program product of claim 7 wherein an electronic prescription generation application accesses the centralized database for the health care practitioner.

12. The program product of claim 7, wherein the interoperable medical code further comprises a medical provider credential that gives access to the centralized database.

13. The program product of claim 2 wherein the patient identifier comprises at least one code for a patient's full name concatenated with a date of birth for the patient and a health care practitioner identifier.

14. The program product of claim 3 further comprising at least one code for an existing patient's status change.

15. The program product of claim 3 further comprising a fingerprint portal for acquiring information of an unconscious patient.

16. The program product of claim 8 further comprising an access of the centralized database by a medical service provider in an access log file.

17. The program product of claim 1 further comprising means for generating a patient report of one or more of prescriptions and clinical information for a patient from the centralized database.

18. The program product of claim 1, further comprising communicating means in a form of one or more of an email, a text, a chat message comprising the interoperable medical code to a medical service provider and means for generating a physical copy of the interoperable medical code.

19. The program product of claim 1, wherein the interoperable medical code is printed as one or more of an alphanumeric string, a barcode, and a Quick Response (QR) code.

20. The program product of claim 7, wherein the patient information comprises different hierarchy levels each accessible by a specified access privilege.

21. The program product of claim 1 further comprising a non-transitory computer readable storage medium storing program code executable by a process to perform operations for:
encoding an interoperable medical code in response to receiving a medical order from a health care practitioner, the interoperable medical code comprising a patient identifier, a practitioner identifier, the medical order, a clinical information address, and an order timestamp;
authenticating the interoperable medical code; and
generating the medical order from the interoperable medical code.

22. The program product of claim 1, the operations further comprising disabling the interoperable medical code in response to a command from the health care practitioner.

23. The program product of claim 1, the operations further comprising validating the health care practitioner using a biometric value.
